(19) United States
(12) Patent Application Publication
(10) Pub. No.: US 2025/0347520 A1
(43) Pub. Date: Nov. 13, 2025

(54) Vehicle Control Device and Vehicle Control Method

(71) Applicants: Hyundai Motor Company, Seoul (KR); Kia Corporation, Seoul (KR)

(72) Inventors: Sung Won Yoon, Hwaseong-si (KR); Jeong Hun Kim, Hwaseong-si (KR)

(21) Appl. No.: 18/928,939

(22) Filed: Oct. 28, 2024

(30) Foreign Application Priority Data
May 7, 2024 (KR) 10-2024-0059943

(51) Int. Cl. G01C 21/30

(52) U.S. Cl. CPC G01C 21/30

(57) ABSTRACT

A vehicle control device includes a processor and memory. The processor may determine, based on a first map, a global path along which a vehicle is to travel, determine, based on a second map associated with the global path and while the vehicle is traveling along the global path, a plurality of local paths associated with the global path, wherein the second map has higher precision than the first map, select, based on a comparison between a plurality of coordinates of the global path and a plurality of coordinates of the plurality of local paths, at least one local path of the plurality of local paths, and control, based on the at least one precise local path, the vehicle.

### CROSS-REFERENCE TO RELATED APPLICATION

This application claims the benefit of priority to Korean Patent Application No. 10-2024-0059943, filed in the Korean Intellectual Property Office on May 7, 2024, the entire contents of which are incorporated herein by reference.

### TECHNICAL FIELD

The present disclosure relates to a vehicle control device and a vehicle control method, and more specifically to a technology for matching a general map and a precision map.

### BACKGROUND

An autonomous driving system may generate a global path using a general map and generate a set of precision map paths corresponding to a relevant set of paths. The general map may express the global path as a set of connected road IDs (identifications). The precision map may be expressed as a set of connected precision map IDs that correspond to respective road IDs. The general map and the precision map have different resolutions (e.g., the precision map providing higher resolution information than the general map), and the creators of the maps may be different. A matching table may be used to match information contained in the general map with information contained in the precision map. The matching table may be constructed to include a precision map ID that matches the general map ID for each road. If the general map ID is changed through updating of the general map (e.g., creation/deletion of roads, shape change, etc.), the matching table may also need to be reconfigured. Therefore, a way to match a general map to a precision map without the need for updating the matching table may be beneficial.

### SUMMARY

The present disclosure has been made to solve the above- mentioned problems occurring in at least some implementations while advantages achieved by those implementations are maintained intact.

An aspect of the present disclosure provides a vehicle control device and a vehicle control method capable of mapping a general map and a precision map.

An aspect of the present disclosure provides a vehicle control device and a vehicle control method capable of mapping a general map and a precision map independently of updating the general map.

An aspect of the present disclosure provides a vehicle control device and a vehicle control method capable of mapping a general map and a precision map in real time using the coordinates of the general map as a vehicle travels.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, a vehicle control device may include: a processor; and memory storing instructions. The instructions may be configured to, when executed by the processor, cause the vehicle control device to: determine, based on a first map, a global path along which a vehicle is to travel; and determine, based on a second map associated with the global path and while the vehicle is traveling along the global path, a plurality of local paths associated with the global path. The second map may have higher precision than the first map. The instructions may be further configured to, when executed by the processor, cause the vehicle control device to: select, based on a comparison between a plurality of coordinates of the global path and a plurality of coordinates of the plurality of local paths, at least one local path of the plurality of local paths; and control, based on the at least one local path, the vehicle.

The instructions may be configured to, when executed by the processor, cause the vehicle control device to select the at least one local path by: determining a first set of coordinates of the first map; determining second sets of coordinates of the plurality of local paths; and selecting the at least one local path. The at least one local path may have a minimum cost value that is determined based on a difference between the first set of coordinates and each of the second sets of coordinates.

The instructions may be configured to, when executed by the processor, cause the vehicle control device to determine the difference between the first set of coordinates and each of the second sets of coordinates by matching the first set of coordinates to each of the plurality of local paths.

The instructions may be configured to, when executed by the processor, cause the vehicle control device to select the at least one local path by stopping, based on the global path that includes a curved path, matching the first set of coordinates to the curved path.

The instructions may be configured to, when executed by the processor, cause the vehicle control device to select the at least one local path by: determining, based on the global path that includes a curved path, a first global straight path connected to a first end of the curved path and a second global straight path connected to a second end of the curved path; and selecting, among the local paths, a first local straight path corresponding to the first global straight path and a second local straight path corresponding to the second global straight path.

The instructions may be configured to, when executed by the processor, further cause the vehicle control device to select, from the plurality of local paths, a local curved path that corresponds to the curved path and is connected to the first local straight path and the second local straight path.

The instructions may be configured to, when executed by the processor, further cause the vehicle control device to: determine, based on the global path that includes a branch path, a first map branch point of the first map; determine a second map branch point, of the second map, that is different from the first map branch point; and determine a first local branch path and a second local branch path that separate at the second map branch point.

The instructions may be configured to, when executed by the processor, cause the vehicle control device to select the at least one local path by: determining, while the vehicle is traveling along the global path, a first set of coordinates of the global path; determining a second set of coordinates of the first local branch path; determining a third set of coordinates of the second local branch path; and selecting, based on a difference between the first set of coordinates and the second set of coordinates and based on a difference between the first set of coordinates and the third set of coordinates, at least one of the first local branch path or the second local branch path.

The instructions may be configured to, when executed by the processor, cause the vehicle control device to select the at least one local path by: determining a first global branch path and a second global branch path that separate at the first map branch point in the global path; and selecting at least one of the first local branch path or the second local branch path, based on at least one of the first global branch path, the second global branch path, the first local branch path, or the second local branch path.

The instructions may be configured to, when executed by the processor, cause the vehicle control device to determine the global path by: determining, based on an input indicating a destination of the vehicle, the global path from a current location of the vehicle to the destination of the vehicle.

According to one or more example embodiments of the present disclosure, a vehicle control method may be performed by a device associated with a vehicle. The vehicle control method may include: determining, based on a first map, a global path along which the vehicle is to travel; determining, based on a second map associated with the global path and while the vehicle is traveling along the global path, a plurality of local paths associated with the global path. The second map may have higher precision than the first map. The vehicle control method may further include: selecting, based on a comparison between a plurality of coordinates of the global path and a plurality of coordinates of the plurality of local paths, at least one local path of the plurality of local paths; and controlling, based on the at least one local path, the vehicle.

Selecting the at least one local path may include: determining a first set of coordinates of the first map; determining second sets of coordinates of the plurality of local paths; and selecting the at least one local path. The at least one local path may have a minimum cost value that is determined based on a difference between the first set of coordinates and each of the second sets of coordinates.

Selecting the at least one local path may include determining the difference between the first set of coordinates and each of the second sets of coordinates by matching the first set of coordinates to each of the plurality of local paths.

Selecting the at least one local path may include stopping, based on the global path that includes a curved path, matching the first set of coordinates to the curved path.

Selecting the at least one local path may include: determining, based on the global path that includes a curved path, a first global straight path connected to a first end of the curved path and a second global straight path connected to a second end of the curved path; and selecting, among the local paths, a first local straight path corresponding to the first global straight path and a second local straight path corresponding to the second global straight path.

Selecting the first local straight path and the second local straight path may include selecting, from the plurality of local paths, a local curved path that corresponds to the curved path and is connected to the first local straight path and the second local straight path.

Selecting the at least one local path may include: determining, based on the global path that includes a branch path, a first map branch point of the first map; determining a second map branch point, of the second map, that is different from the first map branch point; and determining a first local branch path and a second local branch path that separate at the second map branch point.

Selecting the at least one local may include: determining, while the vehicle is traveling along the global path, a first set of coordinates of the global path; determining a second set of coordinates of the first local branch path; determining a third set of coordinates of the second local branch path; and selecting, based on a difference between the first set of coordinates and the second set of coordinates and based on a difference between the first set of coordinates and the third set of coordinates, at least one of the first local branch path or the second local branch path.

Selecting the at least one local may include: determining a first global branch path and a second global branch path that separate at the first map branch point in the global path; and selecting at least one of the first local branch path or the second local branch path, based on at least one of the first global branch path, the second global branch path, the first local branch path, or the second local branch path.

Determining the global path may include: determining, based on an input indicating a destination of the vehicle, the global path from a current location of the vehicle to the destination of the vehicle.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a block diagram related to a vehicle control device;

FIG. 2 shows an example for describing the operation of a vehicle control device matching a general map and a precision map;

FIG. 3 shows an example for describing an operation of a vehicle control device for identifying a precise path corresponding to a curved path;

FIG. 4 shows an example for describing an operation in which a vehicle control device identifies a precise path corresponding to a branch path;

FIG. 5 shows an example of a flowchart showing the operation of a vehicle control device; and

FIG. 6 shows a computing system related to a vehicle control device or a vehicle control method.

### DETAILED DESCRIPTION

Hereinafter, one or more example embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the example embodiment of the present disclosure, a detailed description of well-known features or functions will be ruled out in order not to unnecessarily obscure the gist of the present disclosure.

In describing the components of the one or more example embodiments according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

The term “module” used in various example embodiments of the present disclosure may represent, for example, a unit including one or more combinations of hardware, software and firmware. The term “module” may be interchangeably used with the terms “unit”, “logic”, “logical block”, “part” and “circuit”. The “module” may be a minimum unit of an integrated part or a part thereof or may be a minimum unit for performing one or more functions or a part thereof. The module may be implemented in the form of an application-specific integrated circuit (ASIC). Operations performed by modules, programs, or other components may be executed sequentially, in parallel, or repeatedly, or one or more of the operations may be executed in a different order, omitted, or one or more other operations may be added.

Various example embodiments of the present disclosure may be implemented with software (e.g., a program) that includes one or more instructions stored in a storage medium (e.g., internal memory or external memory) which is readable by a machine (e.g., a vehicle control device 100). For example, a processor (e.g., a processor 110) of a device (e.g., the vehicle control device 100) may call at least one instruction among one or more instructions stored from a storage medium and execute the at least one instruction. This enables the device to be operated to perform at least one function according to the at least one command invoked. The one or more instructions may contain a code made by a compiler or a code executable by an interpreter. The machine- readable storage medium may be provided in the form of a non- transitory storage medium. Here, the term “non-transitory storage medium” may mean that the storage medium is a tangible device and does not include signals (e.g., electromagnetic waves), and may mean that data may be semi-permanently or temporarily stored in the storage medium.

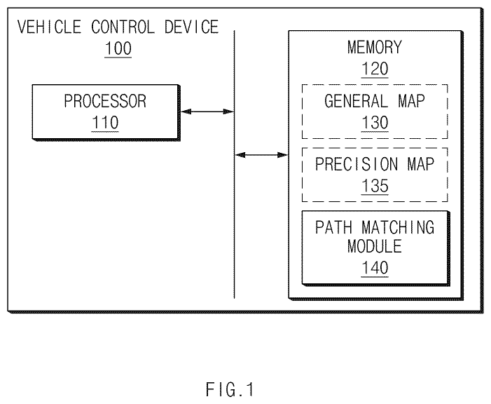

Hereinafter, one or more example embodiments of the present disclosure will be described in detail with reference to FIGS. 1 to 6.

FIG. 1 shows an example of a block diagram related to a vehicle control device.

Referring to FIG. 1, the vehicle control device 100 may be implemented inside or outside a vehicle, and part of components included in the vehicle control device 100 may be implemented inside or outside the vehicle. In this case, the vehicle control device 100 may be integrally formed with internal control units of the vehicle, or may be implemented as a separate device and connected to the control units of the vehicle by separate connection means.

The vehicle control device 100 may include at least one of the processor 110 or a memory 120. The processor 110 and the memory 120 may be electronically and/or operably coupled with each other by an electronical component including a communication bus. Hereinafter, hardware being operatively combined may mean that a direct connection or an indirect connection between the hardware is established in a wired or wireless manner, such that second hardware is controlled by first hardware among the hardware. Although shown based on different blocks, the present discourse is not limited thereto, and a portion of the hardware in FIG. 1 (e.g., at least a portion of the processor 110, the memory 120, and a communication circuitry (not shown)) may be included in a single integrated circuit, such as a system on a chip. For example, the vehicle control device 100 may further include components not shown in FIG. 1. As an example, the vehicle control device 100 may further include a navigation module (or navigation system) for identifying the location of a vehicle, and/or an autonomous driving module (or autonomous driving system) for controlling the vehicle. As an example, the vehicle control device 100 may control the vehicle using an autonomous driving module along a global path identified through a navigation module.

The processor 110 of the vehicle control device 100 may include a hardware component for processing data based on one or more instructions. The hardware component for processing data may include, for example, an arithmetic and logic unit (ALU), a floating point unit (FPU), a field programmable gate array (FPGA), a central processing unit (CPU), a micro controller unit (MCU) and/or an application processor (AP). The number of processors 110 may be one or more. For example, the processor 110 may have the structure of a multi-core processor including dual core, quad core, hexa core, or octa core.

The memory 120 of the vehicle control device 100 may include hardware components for storing data and/or instructions that are input to and/or output from the processor 110. For example, the memory 120 may include a volatile memory, such as a random-access memory (RAM), and/or a non-volatile memory, such as a read-only memory (ROM). For example, the volatile memory may include at least one of dynamic RAM (DRAM), static RAM (SRAM), cache RAM and pseudo SRAM (PSRAM). For example, the non-volatile memory may include at least one of programmable ROM (PROM), erasable PROM (EPROM), electrically erasable PROM (EEPROM), flash memory, hard disk, compact disc, and embedded multi-media card (eMMC).

The vehicle control device 100 may include a general map 130 (e.g., a first map) and/or a precision map 135 (e.g., a second map). For example, resolutions corresponding to the general map 130 and the precision map 135 may be different. For example, the precision map may have higher precision (e.g., higher resolution, more information, etc.) than the general map. For example, companies that manage (or create) the general map 130 and the precision map 135 may be different. However, the present disclosure is not limited thereto. The general map and/or the precision map may be a high density (HD) map that may include various road data necessary for autonomous driving, which includes, for example, lanes (e.g., a number and orientation of lanes), traffic lights (e.g., location and status of traffic lights), signs (e.g., location and status of road signs), road conditions (e.g., potholes, bumps, road texture), traffic flow (e.g., traffic density, speeds, patterns), obstacles and hazard information (e.g., construction zones, debris, pedestrians), location of crosswalks and pedestrian paths, layouts of intersections, and roadside features (e.g., barriers, guardrails, sidewalks, edges). For example, a grid map may be used and may include a representation of a physical space where the area may be divided into a uniform grid of cells or squares, with each cell corresponding to a specific location in the real world. Each cell in the grid may contain data or attributes, such as whether the area is occupied, free, or has certain characteristics such as elevation or cost. The simplicity of the grid structure makes it easier to process and/or apply algorithms for movement, exploration, and mapping in both 2D and 3D environments.

For example, the general map 130 may include relatively general road information (or geographic information) than the precision map 135. For example, the precision map 135 may include relatively more detailed information than the general map 130. As an example, the precision map 135 may include curvature of roads, elevation changes, location of buildings, and/or structure of buildings.

For example, the general map 130 may be expressed as a global path where IDs (identifications) for roads are connected. For example, the precision map 135 may be expressed as a set of connected precision map IDs (or lane IDs) respectively corresponding to road IDs.

For example, the start and end (or one end and the other end) of a road divided using the general map 130 may be different from the start and end of a road divided using the precision map 135. For example, the vehicle control device 100 may control a vehicle according to a precise path (or local path) obtained using the precision map 135 within a road divided using the general map 130. A global path may, for example, include one or more local maps.

The vehicle control device 100 may identify an input indicating the destination of the vehicle. The vehicle control device 100 may identify a global path from the current location of the vehicle to the destination of the vehicle. The vehicle control device 100 may obtain the general map 130 corresponding to the global path from an external server providing a navigation service via a communication circuit.

For example, the vehicle control device 100 may obtain the precision map 135 corresponding to the global path. For example, the vehicle control device 100 may obtain the precision map 135 using a sensor including a LIDAR. The vehicle control device 100 may identify a plurality of precise paths included in the global path using the precision map 135. For example, the plurality of precise paths may be referred to as a plurality of precision map IDs indicating at least one path included in a travel path of the vehicle. The plurality of precision map IDs may include identification information to identify each of the precise paths. The vehicle control device 100 may use information of various sensors (e.g., camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, etc.), for example, for autonomous driving control of the vehicle.

The vehicle control device 100 may select at least one precise path among the plurality of precise paths related to the global path using the precision map 135 while the vehicle is traveling along the global path.

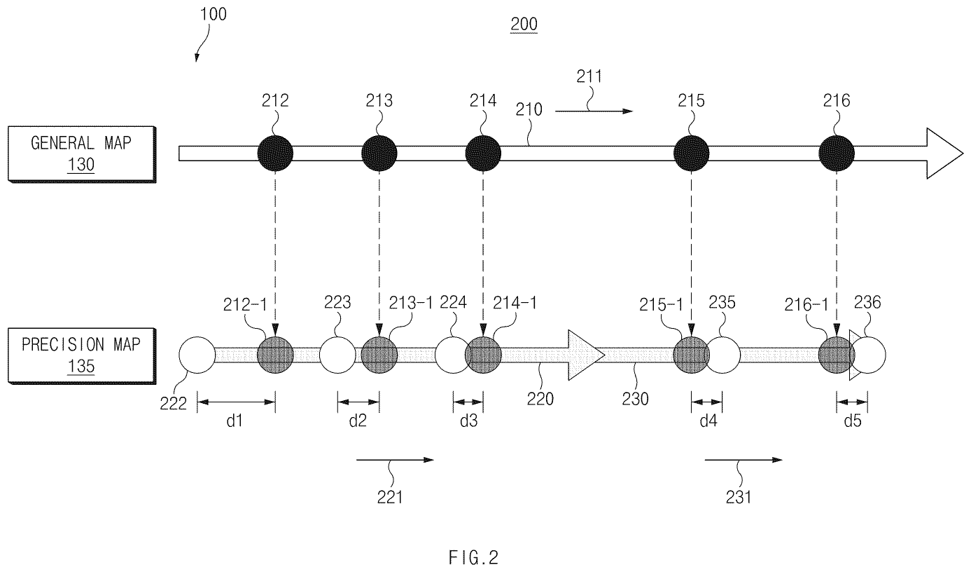

The vehicle control device 100 may select at least one precise path from the plurality of precise paths based on execution of a path matching module 140 while the vehicle is traveling along the global path. The vehicle control device 100 may use the coordinates of the general map and the coordinates of the precision map to select at least one precise path matching the global path. The operation of the vehicle control device 100 to map the general map and the precision map using the coordinates of the general map and the coordinates of the precision map will be described in more detail later with reference to FIGS. 2 to 4.

For example, the vehicle control device 100 may control the vehicle using at least one selected precise path. For example, the vehicle control device 100 may control the vehicle using an autonomous driving module and/or advanced driver assistance systems (ADAS). An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.)

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

As described above, the vehicle control device 100 may map a global path and at least one precise path. The vehicle control device 100 may identify at least one precise path among a plurality of precise paths while the vehicle is traveling along the global path.

For example, the vehicle control device 100 may identify a matching table for matching a general map and a precision map. For example, the matching table may include information about mapping one or more general map IDs and precision map IDs included in the global path. For example, the vehicle control device 100 may use a matching table to control the traveling of the vehicle through a precision map ID corresponding to one or more general map IDs while the vehicle is traveling along a global path.

For example, the vehicle control device 100 may control the vehicle by identifying at least one precise path that is mapped to the global path, based on the execution of the path matching module 140 while bypassing the use of the matching table. For example, the vehicle control device 100 may match the general map and the precision map while the vehicle is traveling without a need to reconfigure (or update) the matching table according to the update of the general map or the precision map. The vehicle control device 100 may reduce time and/or resources for updating the matching table by not updating the matching table.

FIG. 2 shows an example for describing the operation of a vehicle control device matching a general map and a precision map. The vehicle control device 100 of FIG. 2 may be referenced to the vehicle control device 100 of FIG. 1. Referring to FIG. 2, an example 200 for mapping the general map 130 and the precision map 135 including straight roads is shown.

Referring to FIG. 2, the vehicle control device 100 may identify a global path 210 along which a vehicle is to travel using the general map 130. For example, the vehicle control device 100 may identify the global path 210 by obtaining the general map 130 according to a direction of travel of the vehicle.

For example, the global path 210 may include information about the current location of the vehicle and the destination of the vehicle. For example, the global path 210 may correspond to the road ID of at least one of a plurality of roads included between the current location of the vehicle and the destination of the vehicle. However, the present disclosure is not limited thereto.

The vehicle control device 100 may select at least one precise path among the plurality of precise paths related to the global path 210 using the precision map 135 corresponding to the global path 210 while the vehicle is traveling along the global path 210. For example, the plurality of precise paths may represent candidate paths for selecting at least one precise path for controlling the vehicle.

For example, if a difference between a direction 211 of the global path (or the general map 130) 210 and directions 221 and 231 of a plurality of precise paths (or the precision map 135) is within a specified range, the vehicle control device 100 may identify the direction 211 of the global path 210 and the directions 221 and 231 as the same direction.

The vehicle control device 100 may identify the coordinates of the general map 130. The vehicle control device 100 may identify the coordinates of each of the plurality of precise paths. The vehicle control device 100 may select at least one precise path using the difference between the coordinates of the general map 130 and the coordinates of each of the plurality of precise paths.

The vehicle control device 100 may identify one or more coordinates 212, 213, 214, 215, and 216 included in the general map 130 (or global path 210). For example, the vehicle control device 100 may identify the coordinates of each of the plurality of precise paths using the precision map 135. For example, the vehicle control device 100 may match one or more coordinates 212, 213, 214, 215, and 216 to the plurality of precise paths, respectively. The vehicle control device 100 may match one or more coordinates 212, 213, 214, 215, and 216 to the plurality of precise paths, respectively, thereby identifying a difference between the one or more coordinates 212, 213, 214, 215, and 216 and the coordinates of each of the precise paths.

For example, the vehicle control device 100 may match the coordinates 212 of the global path 210 to a first precise path 220. The vehicle control device 100 may identify a difference (e.g., d1 in FIG. 2) between the coordinates 212-1 matched to the first precise path 220 and at least one (e.g., coordinates 222) of the one or more coordinates 222, 223, and 224 included in the first precise path 220. Likewise, the vehicle control device 100 may match the coordinates 213 and 214 of the global path 210 to the first precise path 220. The vehicle control device 100 may identify a difference (e.g., d2 or d3 in FIG. 2) between each of the coordinates 213-1 and 214-1, matched to the first precise path 220, and at least one coordinates (e.g., at least one of the coordinates 223 and 224) of the one or more coordinates 222, 223, and 224 included in the first precise path 220.

For example, the vehicle control device 100 may select at least one precise path (e.g., first precise path 220) where the difference (e.g., d1, d2, and/or d3 in FIG. 2) between coordinates is minimized, among the plurality of precise paths, by using a cost function. The cost function may be expressed as Equation 1.

$$F = d 1 + d 2 + d 3 \qquad [ Equation 1 ]$$

Referring to Equation 1, F may denote a cost function. The cost function may be used to identify a precision map (or precise path) where a difference in location between coordinates is smallest. d1 may denote a difference between coordinates 212-1 and coordinates 222. d2 may denote a difference between coordinates 213-1 and coordinates 223. d3 may denote a difference between coordinates 214-1 and coordinates 224. For example, the vehicle control device 100 may calculate a cost function for each of the plurality of precise paths and then select at least one precise path whose cost function has the minimum value. For example, the difference between the coordinates 222 and the coordinates 212-1 included in the first precise path 220 may have a minimum value.

For example, because the difference between the coordinates 222 and the coordinates 212-1 included in the first precise path 220 is smaller than the difference between the coordinates 235 and the coordinates 215-1 included in a second precise path 230, the vehicle control device 100 may select the first precise path 220 among the first precise path 220 and the second precise path 230. However, the present disclosure is not limited thereto.

For example, the vehicle control device 100 may select at least one precise path using other equations than Equation 1. The other equations may relate to error rates.

The global path 210 may correspond to one or more precise paths as the vehicle travels. For example, the vehicle control device 100 may identify the second precise path 230 among the plurality of precise paths.

The vehicle control device 100 may match the coordinates 215 and 216 to the second precise path 230. The vehicle control device 100 may identify differences (d4 and d5 in FIG. 2) between the matched coordinates 215-1 and 216-1 and the coordinates 235 and 236 included in the second precise path 230. The vehicle control device 100 may identify the differences between the coordinates 215 and 216 and each of the plurality of precise paths. The vehicle control device 100 may control the vehicle using the second precise path 230 if the differences (d4 and d5 in FIG. 2) related to the second precise path 230 have a minimum value. However, the present disclosure is not limited thereto.

As described above, the vehicle control device 100 may identify a global path and a plurality of precise paths, which have a direction corresponding to a direction of travel of the vehicle. The vehicle control device 100 may match a first set of coordinates included in the global path to each of the plurality of precise paths. The vehicle control device 100 may identify a difference between the first set of coordinates matched to each of the plurality of precise paths and a second set of coordinates included in each of the plurality of precise paths. The vehicle control device 100 may use a cost function to identify at least one precise path corresponding to the difference with the minimum value, among the differences between the first set of coordinates and the second set of coordinates. The vehicle control device 100 may identify at least one precise path for controlling the vehicle while the vehicle is traveling along the global path. The vehicle control device 100 may obtain at least one precise path for more accurately controlling the vehicle by matching the general map 130 and the precision map 135 using coordinates.

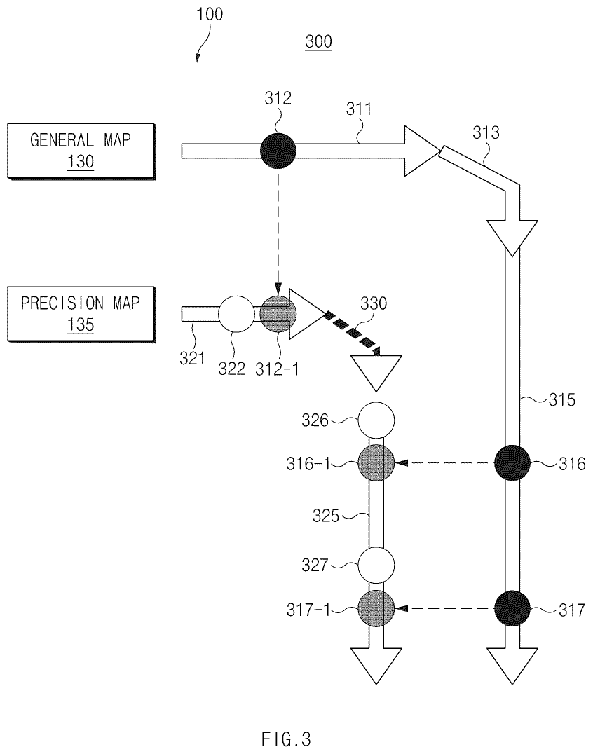

FIG. 3 shows an example for describing an operation in which a vehicle control device identifies a precise path corresponding to a curved path. The vehicle control device 100 of FIG. 3 may be referenced to the vehicle control device 100 of FIG. 1. Referring to FIG. 3, an example 300 for mapping the general map 130 including a curved path and the precision map 135 is shown.

Referring to FIG. 3, if the global path includes a curved path 313, the vehicle control device 100 may identify a first global straight path 311 connected to one end of the curved path 313 and a second global straight path 315 connected to the other end of the curved path 313. The first global straight path 311, the second global straight path 315, and/or the curved path 313 may be included in the global path (e.g., the global path 210 in FIG. 2).

The vehicle control device 100 may select a first precise straight path 321 corresponding to the first global straight path 311 and a second precise straight path 325 corresponding to the second global straight path 315 among a plurality of precise paths, by using the first global straight path 311 and the second global straight path 315.

For example, the vehicle control device 100 may match coordinates 312 included in the first global straight path 311 to the first precise straight path 321. The vehicle control device 100 may identify a difference between coordinates 312-1 matched to the first precise straight path 321 and coordinates 322 included in the first precise straight path 321. If the identified coordinates have the minimum value, the vehicle control device 100 may map the first global straight path 311 and the first precise straight path 321. The vehicle control device 100 may control a vehicle using the first precise straight path 321 while the vehicle is traveling along the first global straight path 311.

For example, the vehicle control device 100 may map coordinates 316 and 317 included in the second global straight path 315 to the second precise straight path 325. For example, the vehicle control device 100 may identify differences between the coordinates 316-1 and 317-1 mapped to the second precise straight path 325 and the coordinates 326 and 327 included in the second precise straight path 325. The vehicle control device 100 may map the second global straight path 315 and the second precise straight path 325 if the identified difference has a minimum value (e.g., if the error rate has a minimum value).

For example, the vehicle control device 100 may identify a precise curved path 330 connected to the first precise straight path 321 and the second precise straight path 325 among a plurality of precise paths based on identifying the first precise straight path 321 and the second precise straight path 325. The vehicle control device 100 may map the precise curved path 330 to the curved path 313. That is, the precise curved path 330 may correspond to the curved path 313.

For example, one end of the precise curved path 330 may be connected to the first precise straight path 321. The other end of the precise curved path 330 may be connected to the second precise straight path 325. Because roads are connected, the vehicle control device 100 may obtain the precise curved path 330 by identifying the first precise straight path 321 and the second precise straight path 325.

As described above, the vehicle control device 100 may identify the curved path 313 included in the general map 130. In the case of a curved path, because the curvature of a road may be different from the curvature of a lane, the vehicle control device 100 may bypass identification of a curved precise path using the coordinates of the curved path. The vehicle control device 100 may use straight paths connected to the curved path to identify precise straight paths mapped to the straight paths, respectively.

For example, because the roads are connected, the vehicle control device 100 may use the precise straight paths to obtain a curved precise path corresponding to the curved path. The vehicle control device 100 may reduce the amount of calculations for mapping the general map 130 and the precision map 135 by using the coordinates of straight paths related to a curved path instead of using the coordinates of the curved path.

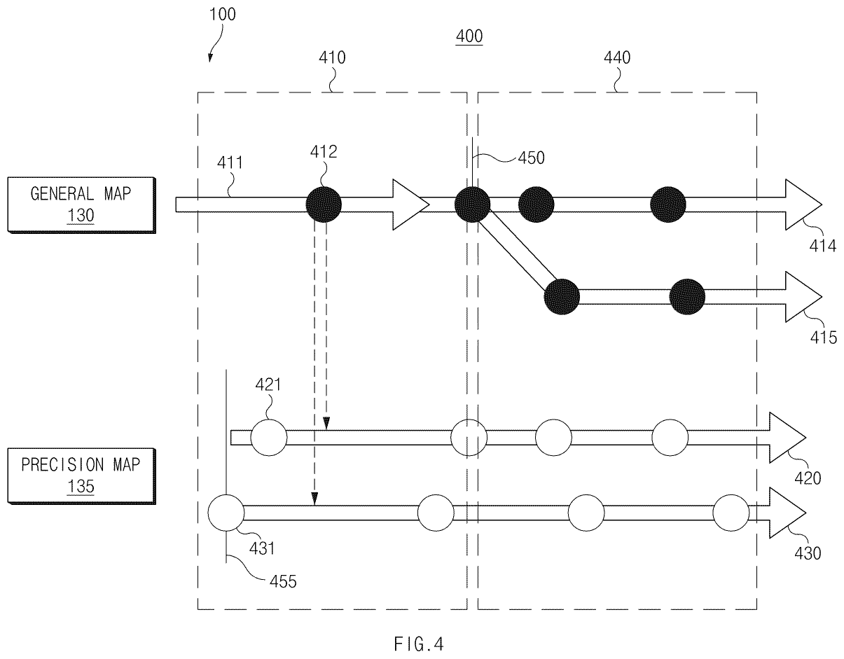

FIG. 4 shows an example for describing an operation in which a vehicle control device identifies a precise path corresponding to a branch path. The vehicle control device 100 of FIG. 4 may be referenced to the vehicle control device 100 of FIG. 1. Referring to FIG. 4, an example 400 for mapping the general map 130 and the precision map 135 including a branch path is shown.

In one example 400, the vehicle control device 100 may identify a general map branch point 450 using the general map 130, if a global path 411 includes a branch path (e.g., a first global branch path 414 and a second global branch path 415).

The vehicle control device 100 may identify a precision map branch point 455 that is ahead of the general map branch point, using the precision map 135. The precision map branch point 455, which is ahead of the general map branch point 450, may be matched with the location of the vehicle before the general map branch point 450 while the vehicle is traveling along a travel path (or global path) of the vehicle. However, the present disclosure is not limited thereto. For example, the precision map branch point 455 may be located later than the general map branch point 450. The precision map branch point 455 and the general map branch point 450 may be defined according to preset values respectively.

For example, the general map branch point 450 may represent a branch of a road, and the precision map branch point 455 may represent a branch at a relatively more precise level (e.g., lane) than the general map, so that the precision map branch point 455 may be located in front of the general map branch point 450. However, the present disclosure is not limited thereto. For example, if the precision map 135 has a higher resolution than the general map 130, branch roads may be expressed before the general map 130, and therefore, the precision map branch point 455 may be ahead of the general map branch point 450. For example, the general map branch point 450 may be placed in the same position as the precision map branch point 455, or may be positioned in front of the precision map branch point 455. That is, the vehicle control device 100 may map the general map 130 and the precision map 135 independently of the relative location of the precision map branch point 455 with respect to the location of the general map branch point 450. The vehicle control device 100 may identify a first section 410 and a second section 440 based on the general map branch point 450.

For example, the first section 410 may include a portion of the global path 411 located ahead of the general map branch point 450. The second section 440 may include a portion of the global path 411 (or branch path) located later than the general map branch point 450. However, the present disclosure is not limited thereto.

The vehicle control device 100 may identify a first precise branch path 420 and a second precise branch path 430 separating (or merging) at the precision map branch point 455.

For example, the vehicle control device 100 may identify the coordinates 412 of the global path 411 located ahead (or behind) the general map branch point 450 as the vehicle travels. For example, the vehicle control device 100 may identify the coordinates 421 of the first precise branch path 420 and the coordinates 431 of the second precise branch path 430. For example, the vehicle control device 100 may select at least one of the first precise branch path 420 and the second precise branch path 430 using a difference between the coordinates 412 and the coordinates 421 and a difference between the coordinates 421 and the coordinates 431.

For example, the vehicle control device 100 may map the coordinates 412 included in the first section 410 to the first precise branch path 420 and the second precise branch path 430 individually. The vehicle control device 100 may identify a first difference between the coordinates mapped to the first precise branch path 420 and the coordinates 421 included in the first precise branch path 420. The vehicle control device 100 may identify a second difference between the coordinates mapped to the second precise branch path 430 and the coordinates 431 included in the second precise branch path 430. The vehicle control device 100 may identify the precision map 135 to be mapped to the general map 130 (or the global path 411) in the first section 410 using the first difference and the second difference. The vehicle control device 100 may control the vehicle using the first precise branch path 420 in the first section 410 if the first difference is smaller than the second difference. The vehicle control device 100 may control the vehicle using the second precise branch path 430 in the first section 410 if the second difference is smaller than the first difference. However, the present disclosure is not limited thereto.

The vehicle control device 100 may identify the first global branch path 414 and the second global branch path 415 separating (or merging) at the general map branch point 450 in the global path 411. The first global branch path 414 and the second global branch path 415 may be included in the second section 440. For example, the vehicle control device 100 may select at least one of the first precise branch path 420 and the second precise branch path 430 using at least one of the first global branch path 414, the second global branch path 415, the first precise branch path 420, or the second precise branch path 430 or any combination thereof. The vehicle control device 100 may map the precision map 135 and the general map 130 using at least one selected.

For example, the vehicle control device 100 may perform an operation to map the general map 130 and the precision map 135 in the first section 410 and an operation to map the general map 130 and the precision map 135 in the second section 440 in parallel. The vehicle control device 100 may identify a precise path corresponding to a travel path of the vehicle along which the vehicle is traveling along the global path 411 by using the results of the mapping performed in the first section 410 and the results of the mapping performed in the second section 440. However, the present disclosure is not limited thereto. For example, the results of mapping may include information about the precise path mapped to the global path 411.

As described above, if a branch path is identified, the vehicle control device 100 may determine whether to map branch paths (e.g., the first global branch path 414 and the second global branch path 415) separating (or merging) at the general map branch point 450, to precise branch paths, respectively. The vehicle control device 100 may more accurately obtain precise paths mapped to the travel path (or global path 411) of the vehicle by using the results of mapping of the general map 130 and the precision map 135 performed in the section (e.g., the first section 410) before the general map branch point 450 and the results of mapping of the general map 130 and the precision map 135 performed in the section (e.g., the second section 440) after the general map branch point 450.

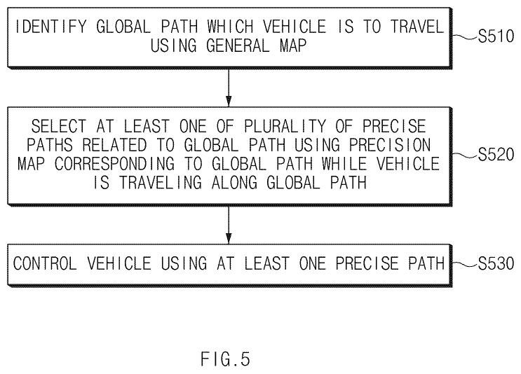

FIG. 5 shows an example of a flowchart showing the operation of a vehicle control device. Hereinafter, it is assumed that the vehicle control device 100 of FIG. 1 performs the process of FIG. 5. Additionally, in the description of FIG. 5, operations described as being performed by the device may be understood as being controlled by the processor 110 of the vehicle control device 100. The operations in FIG. 5 may be performed sequentially, but is not necessarily performed sequentially. For example, the order of the operations may be changed, and at least two operations may be performed in parallel.

The vehicle control device may identify a global path along which a vehicle is to travel using a general map in operation S510.

For example, a vehicle control device may identify the global path from the current location of the vehicle to the destination of the vehicle in response to an input indicating the destination of the vehicle. Based on identifying the global path, the vehicle control device may obtain a plurality of precise paths to be used to control the vehicle along the global path using a precision map.

In operation S520, the vehicle control device may select at least one of a plurality of precise paths related to the global path using the precision map corresponding to the global path, while the vehicle is traveling along the global path.

For example, the vehicle control device may select at least one of the plurality of precise paths using a decision logic for comparing a plurality of coordinates of the global path and a plurality of coordinates of the plurality of precise paths. Decision logic may be referred to as a specified function.

For example, the vehicle control device may identify at least one precise path using a difference between the coordinates of each of the plurality of precise paths and coordinates included in a portion of the global path.

The vehicle control device may select at least one precise path using differences between a first set of coordinates of the general map and second sets of coordinates of the plurality of precise paths. For example, the vehicle control device may select at least one precise path in which the value of a decision logic (e.g., cost function) has the minimum value using the difference between the first set of coordinates and each of the second sets of coordinates. For example, the vehicle control device may identify the difference between the first set of coordinates and each of the second sets of coordinates by matching the first set of coordinates to each of the plurality of precise paths. For example, the vehicle control device may stop matching the first set of coordinates of the general map to a curved path if the global path includes a curved path.

For example, if the global path includes a curved path, the vehicle control device may identify a precise straight path corresponding to a straight path using the coordinates of the straight path connected to the curve path, by bypassing identification of the precise curved path using the coordinates of the curved path. The vehicle control device may identify a precise curved path connected to the precise straight path using the precise straight path.

For example, if the global path includes branch paths, the vehicle control device may compare the coordinates of each of the branch paths and the coordinates of each of the precise branch paths to identify a branch path that matches the travel path of the vehicle and a precise branch path corresponding to the branch path.

The vehicle control device may control the vehicle using at least one precise path in operation S530. The vehicle control device may control the vehicle based on a driver assistance system. However, the present disclosure is not limited thereto.

Based on the update of the general map and/or the precision map, the vehicle control device as described above may map a general map and a precision map by comparing the coordinates of the general map and the coordinates of the precision map according to the travel path of the vehicle without a need to update the matching table.

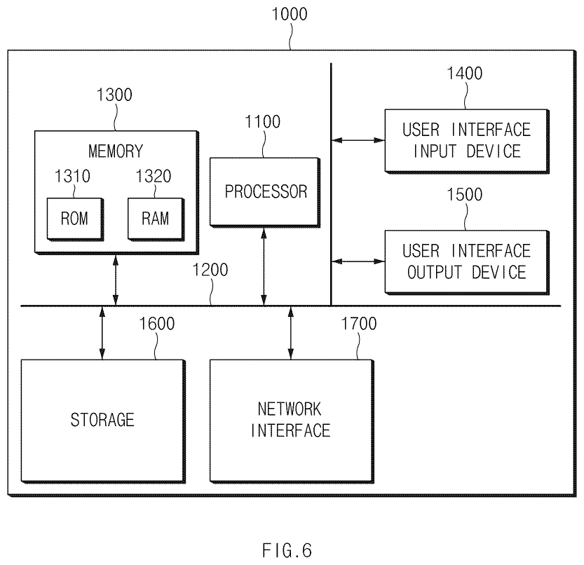

FIG. 6 shows a computing system related to a vehicle control device or a vehicle control method.

Referring to FIG. 6, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a Read Only Memory (ROM) and a Random Access Memory (RAM).

Thus, the operations of the method or the algorithm described herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM.

The exemplary storage medium may be coupled to the processor 1100, and the processor 1100 may read information out of the storage medium and may record information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

According to an aspect of the present disclosure, a vehicle control device may include a processor and a memory. The processor may identify a global path along which a vehicle is to travel, using a general map, identify a plurality of precise paths related to the global path using a precision map corresponding to the global path, while the vehicle is traveling along the global path, select at least one of the plurality of precise paths using a decision logic for comparing a plurality of coordinates of the global path and a plurality of coordinates of the plurality of precise paths, and control the vehicle using the at least one precise path.

According to an embodiment, the processor may identify a first set of coordinates of the general map, identify second sets of coordinates of the plurality of precise paths, and select the at least one precise path where a value of the decision logic has a minimum value, using a difference between the first set of coordinates and each of the second sets of coordinates.

According to an embodiment, the processor may identify the difference between the first set of coordinates and each of the second sets of coordinates by matching the first set of coordinates to each of the plurality of precise paths.

According to an embodiment, the processor may stop matching the first set of coordinates to a curved path if the global path includes the curved path.

According to an embodiment, the processor may identify a first global straight path connected to one end of a curved path and a second global straight path connected to the other end of the curved path if the global path includes the curved path, and select a first precise straight path corresponding to the first global straight path and a second precise straight t path corresponding to the second global straight path among the precise paths, using the first global straight path and the second global straight path.

According to an embodiment, the processor may select, from among the plurality of precise paths, a precise curved path connected to the first precise straight path and the second precise straight path, a precise curved path corresponding to the curved path.

According to an embodiment, the processor may identify a general map branch point using the general map if the global path includes a branch path, identify a precision map branch point that is different from the general map branch point, using the precision map, and identify a first precise branch path and a second precise branch path separated at the precision map branch point.

According to an embodiment, the processor may identify a fourth set of coordinates of the global path as the vehicle travels, identify a fifth set of coordinates of the first precise branch path and a sixth set of coordinates of the second precise branch path, and select at least one of the first precise branch path and the second precise branch path using a difference between the fourth set of coordinates and the fifth set of coordinates, and a difference between the fourth set of coordinates and the sixth set of coordinates.

According to an embodiment, the processor may identify a first global branch path and a second global branch path separated at the general map branch point in the global path, and select at least one of the first precise branch path and the second precise branch path using at least one of the first global branch path, the second global branch path, the first precise branch path, or the second precise branch path, or any combination thereof.

According to an embodiment, the processor may identify the global path from a current location of the vehicle to a destination of the vehicle, in response to an input indicating the destination of the vehicle, and obtain the plurality of precise paths to be used to control the vehicle along the global path using the precision map based on identifying the global path.

According to an aspect of the present disclosure, a vehicle control method may include identifying a global path along which a vehicle is to travel, using a general map, identifying a plurality of precise paths related to the global path using a precision map corresponding to the global path, while the vehicle is traveling along the global path, selecting at least one of the plurality of precise paths using a decision logic for comparing a plurality of coordinates of the global path and a plurality of coordinates of the plurality of precise paths, and controlling the vehicle using the at least one precise path.

According to an embodiment, the selecting of the at least one of the plurality of precise paths may include identifying a first set of coordinates of the general map, identifying second sets of coordinates of the plurality of precise paths, and selecting the at least one precise path where a value of the decision logic has a minimum value, using differences between the first set of coordinates and the second sets of coordinates.

According to an embodiment, the selecting of the at least one of the plurality of precise paths may include identifying the difference between the first set of coordinates and each of the second sets of coordinates by matching the first set of coordinates to each of the plurality of precise paths.

According to an embodiment, the selecting of the at least one of the plurality of precise paths may include stopping matching the first set of coordinates to a curved path if the global path includes the curved path.

According to an embodiment, the selecting of the at least one of the plurality of precise paths may include identifying a first global straight path connected to one end of a curved path and a second global straight path connected to the other end of the curved path if the global path includes the curved path, and selecting a first precise straight path corresponding to the first global straight path and a second precise straight path corresponding to the second global straight path among the precise paths, using the first global straight path and the second global straight path.

According to an embodiment, the selecting of the first precise straight path and the second precise straight path may include selecting, from among the plurality of precise paths, a precise curved path connected to the first precise straight path and the second precise straight path, a precise curved path corresponding to the curved path.

According to an embodiment, the selecting of the at least one of the plurality of precise paths may include identifying a general map branch point using the general map if the global path includes a branch path, identifying a precision map branch point that is different from the general map branch point, using the precision map, and identifying a first precise branch path and a second precise branch path separated at the precision map branch point.

According to an embodiment, the identifying of the first precise branch path and the second precise branch path may include identifying a fourth set of coordinates of the global path as the vehicle travels, identifying a fifth set of coordinates of the first precise branch path and a sixth set of coordinates of the second precise branch path, and selecting at least one of the first precise branch path and the second precise branch path using a difference between the fourth set of coordinates and the fifth set of coordinates, and a difference between the fourth set of coordinates and the sixth set of coordinates.

According to an embodiment, the identifying of the first precise branch path and the second precise branch path may include identifying a first global branch path and a second global branch path separated at the general map branch point in the global path, and selecting at least one of the first precise branch path and the second precise branch path using at least one of the first global branch path, the second global branch path, the first precise branch path, or the second precise branch path, or any combination thereof.

According to an embodiment, the identifying of the global path may include identifying the global path from a current location of the vehicle to a destination of the vehicle, in response to an input indicating the destination of the vehicle and obtaining the plurality of precise paths to be used to control the vehicle along the global path using the precision map based on identifying the global path.

The above description is merely illustrative of the technical idea of the present disclosure, and various modifications and variations may be made without departing from the essential characteristics of the present disclosure by those skilled in the art to which the present disclosure pertains.

Accordingly, the one or more example embodiments disclosed in the present disclosure are not intended to limit the technical idea of the present disclosure but to describe the present disclosure, and the scope of the technical idea of the present disclosure is not limited by the example embodiments. The scope of protection of the present disclosure should be interpreted by the following claims, and all technical ideas within the scope equivalent thereto should be construed as being included in the scope of the present disclosure.

The present technology is intended to map a general map and a precision map.

The present technology is intended to map a general map and a precision map independently of updating the general map.

Further, the present technology is intended to map a general map and a precision map in real time using the coordinates of the general map as a vehicle travels.

In addition, various effects may be provided that are directly or indirectly understood through the disclosure.

Hereinabove, although the present disclosure has been described with reference to example embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A vehicle control device comprising:
a processor; and
memory storing instructions that are configured to, when executed by the processor, cause the vehicle control device to:
determine, based on a first map, a global path along which a vehicle is to travel;
determine, based on a second map associated with the global path and while the vehicle is traveling along the global path, a plurality of local paths associated with the global path, wherein the second map has higher precision than the first map;
select, based on a comparison between a plurality of coordinates of the global path and a plurality of coordinates of the plurality of local paths, at least one local path of the plurality of local paths; and
control, based on the at least one local path, the vehicle.

2. The vehicle control device of claim 1, wherein the instructions are configured to, when executed by the processor, cause the vehicle control device to select the at least one local path by:
determining a first set of coordinates of the first map;
determining second sets of coordinates of the plurality of local paths; and
selecting the at least one local path, wherein the at least one local path has a minimum cost value that is determined based on a difference between the first set of coordinates and each of the second sets of coordinates.

3. The vehicle control device of claim 2, wherein the instructions are configured to, when executed by the processor, cause the vehicle control device to determine the difference between the first set of coordinates and each of the second sets of coordinates by matching the first set of coordinates to each of the plurality of local paths.

4. The vehicle control device of claim 3, wherein the instructions are configured to, when executed by the processor, cause the vehicle control device to select the at least one local path by stopping, based on the global path comprising a curved path, matching the first set of coordinates to the curved path.

5. The vehicle control device of claim 1, wherein the instructions are configured to, when executed by the processor, cause the vehicle control device to select the at least one local path by:
determining, based on the global path comprising a curved path, a first global straight path connected to a first end of the curved path and a second global straight path connected to a second end of the curved path; and
selecting, among the local paths, a first local straight path corresponding to the first global straight path and a second local straight path corresponding to the second global straight path.

6. The vehicle control device of claim 5, wherein the instructions are configured to, when executed by the processor, further cause the vehicle control device to select, from the plurality of local paths, a local curved path that corresponds to the curved path and is connected to the first local straight path and the second local straight path.

7. The vehicle control device of claim 1, wherein the instructions are configured to, when executed by the processor, further cause the vehicle control device to:
determine, based on the global path comprising a branch path, a first map branch point of the first map;
determine a second map branch point, of the second map, that is different from the first map branch point; and
determine a first local branch path and a second local branch path that separate at the second map branch point.

8. The vehicle control device of claim 7, wherein the instructions are configured to, when executed by the processor, cause the vehicle control device to select the at least one local path by:
determining, while the vehicle is traveling along the global path, a first set of coordinates of the global path;
determining a second set of coordinates of the first local branch path;
determining a third set of coordinates of the second local branch path; and
selecting, based on a difference between the first set of coordinates and the second set of coordinates and based on a difference between the first set of coordinates and the third set of coordinates, at least one of the first local branch path or the second local branch path.

9. The vehicle control device of claim 7, wherein the instructions are configured to, when executed by the processor, cause the vehicle control device to select the at least one local path by:
determining a first global branch path and a second global branch path that separate at the first map branch point in the global path; and
selecting at least one of the first local branch path or the second local branch path, based on at least one of the first global branch path, the second global branch path, the first local branch path, or the second local branch path.

10. The vehicle control device of claim 1, wherein the instructions are configured to, when executed by the processor, cause the vehicle control device to determine the global path by:
determining, based on an input indicating a destination of the vehicle, the global path from a current location of the vehicle to the destination of the vehicle.

11. A vehicle control method performed by a device associated with a vehicle, the vehicle control method comprising:
determining, based on a first map, a global path along which the vehicle is to travel;
determining, based on a second map associated with the global path and while the vehicle is traveling along the global path, a plurality of local paths associated with the global path, wherein the second map has higher precision than the first map;
selecting, based on a comparison between a plurality of coordinates of the global path and a plurality of coordinates of the plurality of local paths, at least one local path of the plurality of local paths; and
controlling, based on the at least one local path, the vehicle.

12. The vehicle control method of claim 11, wherein the selecting of the at least one local path comprises:
determining a first set of coordinates of the first map;
determining second sets of coordinates of the plurality of local paths; and
selecting the at least one local path, wherein the at least one local path has a minimum cost value that is determined based on a difference between the first set of coordinates and each of the second sets of coordinates.

13. The vehicle control method of claim 12, wherein the selecting of the at least one local path comprises determining the difference between the first set of coordinates and each of the second sets of coordinates by matching the first set of coordinates to each of the plurality of local paths.

14. The vehicle control method of claim 13, wherein the selecting of the at least one local path comprises stopping, based on the global path comprising a curved path, matching the first set of coordinates to the curved path.

15. The vehicle control method of claim 11, wherein the selecting of the at least one local path comprises:
determining, based on the global path comprising a curved path, a first global straight path connected to a first end of the curved path and a second global straight path connected to a second end of the curved path; and
selecting, among the local paths, a first local straight path corresponding to the first global straight path and a second local straight path corresponding to the second global straight path.

16. The vehicle control method of claim 15, wherein the selecting of the first local straight path and the second local straight path comprises selecting, from the plurality of local paths, a local curved path that corresponds to the curved path and is connected to the first local straight path and the second local straight path.

17. The vehicle control method of claim 11, wherein the selecting of the at least one local path comprises:
determining, based on the global path comprising a branch path, a first map branch point of the first map;
determining a second map branch point, of the second map, that is different from the first map branch point; and
determining a first local branch path and a second local branch path that separate at the second map branch point.

18. The vehicle control method of claim 17, wherein the selecting of the at least one local comprises:
determining, while the vehicle is traveling along the global path, a first set of coordinates of the global path;
determining a second set of coordinates of the first local branch path;
determining a third set of coordinates of the second local branch path; and
selecting, based on a difference between the first set of coordinates and the second set of coordinates and based on a difference between the first set of coordinates and the third set of coordinates, at least one of the first local branch path or the second local branch path.

19. The vehicle control method of claim 17, wherein the selecting of the at least one local comprises:
determining a first global branch path and a second global branch path that separate at the first map branch point in the global path; and
selecting at least one of the first local branch path or the second local branch path, based on at least one of the first global branch path, the second global branch path, the first local branch path, or the second local branch path.

20. The vehicle control method of claim 11, wherein the determining of the global path comprises:
determining, based on an input indicating a destination of the vehicle, the global path from a current location of the vehicle to the destination of the vehicle.
